(19) United States
(12) Patent Application Publication
(10) Pub. No.: US 2026/0050547 A1
(43) Pub. Date: Feb. 19, 2026

(54) MEMORY MANAGEMENT METHOD, MEMORY STORAGE DEVICE AND MEMORY CONTROL CIRCUIT UNIT

(71) Applicant: PHISON ELECTRONICS CORP., Miaoli (TW)

(72) Inventors: Kuei An Yang, New Taipei City (TW); Hsin-Yu Chang, New Taipei City (TW)

(73) Assignee: PHISON ELECTRONICS CORP., Miaoli (TW)

(21) Appl. No.: 18/882,771

(22) Filed: Sep. 12, 2024

(30) Foreign Application Priority Data
Aug. 13, 2024 (TW) 113130309

(51) Int. Cl. G06F 12/02

(52) U.S. Cl. CPC G06F 12/0246

(57) ABSTRACT

A memory management method, a memory storage device and a memory control circuit unit are disclosed. The method includes: setting an initial value of count information corresponding to at least one of a plurality of physical management units to be greater than zero; setting initial values of count information corresponding to at least two of the physical management units to be different from each other; and updating first count information corresponding to a first physical management unit among the physical management units according to a first operation performed on the first physical management unit, wherein the first count information reflects a reference number of times of performing the first operation on the first physical management unit, and the reference number of times is greater than an actual number of times of performing the first operation on the first physical management unit.

### CROSS-REFERENCE TO RELATED APPLICATION

This application claims the priority benefit of Taiwan application serial no. 113130309, filed on Aug. 13, 2024. The entirety of the above-mentioned patent application is hereby incorporated by reference herein and made a part of this specification.

### BACKGROUND

### Technical Field

The disclosure relates to a memory management method, a memory storage device, and a memory control circuit unit.

### Description of Related Art

The rapid growth of portable electronic devices such as mobile phones and laptops in recent years has led to a rapid increase in consumer demand for storage media. Since a rewritable non-volatile memory module (e.g. a flash memory) has the characteristics of data non-volatility, power saving, small size, and having no mechanical structure, it is very suitable for being built in a variety of portable electronic devices as exemplified above.

Some types of memory controllers support checking the more heavily used memory blocks after a rewritable non-volatile memory module has been used for a period of time, to ensure the correctness of the data stored in the rewritable non-volatile memory module. However, if there are too many memory blocks that need to be checked at the same time, it may result in a situation where certain memory blocks, despite having met the requisite checking condition, experience significant delays in undergoing checks and/or data updates. In this case, errors may occur in subsequent operations on the memory block, and the service life of the memory storage device may even be shortened.

### SUMMARY

A memory management method, a memory storage device and a memory control circuit unit, which can improve the aforementioned issues, are provided in the disclosure.

An exemplary embodiment of the disclosure provides a memory management method for a rewritable non-volatile memory module, in which the rewritable non-volatile memory module includes multiple physical management units, and the memory management method includes the following operation. An initial value of count information corresponding to at least one of the physical management units is set to be greater than zero. Initial values of count information corresponding to at least two of the physical management units are set to be different from each other. First count information corresponding to a first physical management unit among the physical management units is updated according to a first operation performed on the first physical management unit, in which the first count information reflects a reference number of times of performing the first operation on the first physical management unit, and the reference number of times is greater than an actual number of times of performing the first operation on the first physical management unit.

An exemplary embodiment of the disclosure further provides a memory storage device, which includes a connection interface unit, a rewritable non-volatile memory module, and a memory control circuit unit. The connection interface unit is configured to couple to a host system. The memory control circuit unit is coupled to the connection interface unit and the rewritable non-volatile memory module. The rewritable non-volatile memory module includes multiple physical management units, and the memory control circuit unit is configured to perform the following operation. An initial value of count information corresponding to at least one of the physical management units is set to be greater than zero. Initial values of count information corresponding to at least two of the physical management units are set to be different from each other. First count information corresponding to a first physical management unit among the physical management units is updated according to a first operation performed on the first physical management unit, in which the first count information reflects a reference number of times of performing the first operation on the first physical management unit, and the reference number of times is greater than an actual number of times of performing the first operation on the first physical management unit.

An exemplary embodiment of the disclosure further provides a memory control circuit unit for controlling a memory storage device. The memory storage device includes a rewritable non-volatile memory module, and the memory control circuit unit includes a host interface, a memory interface and a memory management circuit. The host interface is configured to couple to a host system. The memory interface is configured to couple to the rewritable non-volatile memory module. The memory management circuit is coupled to the host interface and the memory interface. The rewritable non-volatile memory module includes multiple physical management units, and the memory management circuit is configured to perform the following operation. An initial value of count information corresponding to at least one of the physical management units is set to be greater than zero. Initial values of count information corresponding to at least two of the physical management units are set to be different from each other. First count information corresponding to a first physical management unit among the physical management units is updated according to a first operation performed on the first physical management unit, in which the first count information reflects a reference number of times of performing the first operation on the first physical management unit, and the reference number of times is greater than an actual number of times of performing the first operation on the first physical management unit.

Based on the above, for the management of the count information, the disclosure proposes to set the initial value of the count information corresponding to at least one of the physical management units to be greater than zero, and to set the initial values of count information corresponding to at least two of the physical management units to be different from each other. Thereafter, the first count information corresponding to the first physical management unit among the physical management units may be updated according to a first operation performed on a first physical management unit to reflect the reference number of times the first operation is performed on the first physical management unit. In particular, the reference number of times may be greater than the actual number of times of performing the first operation on the first physical management unit. This can improve a series of problems that may arise from the excessive number of physical management units (such as memory blocks) that need to be checked at the same time, thereby extending the service life of the memory storage device.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a schematic diagram of setting customized initial values of the count information for multiple physical management units according to an exemplary embodiment of the disclosure.

FIG. 8 to FIG. 11 are schematic diagrams of updating count information based on the customized initial value of the count information and performing corresponding operation according to exemplary embodiments of the disclosure.

FIG. 12 is a schematic diagram of resetting count information according to an exemplary embodiment of the disclosure.

FIG. 13 is a flowchart of a memory management method according to an exemplary embodiment of the disclosure.

### DETAILED DESCRIPTION OF DISCLOSED EMBODIMENTS

In general, a memory storage device (also referred to as a memory storage system) includes a rewritable non-volatile memory module and a controller (also referred to as a control circuit). The memory storage device can be used with a host system so that the host system can write data to or read data from the memory storage device.

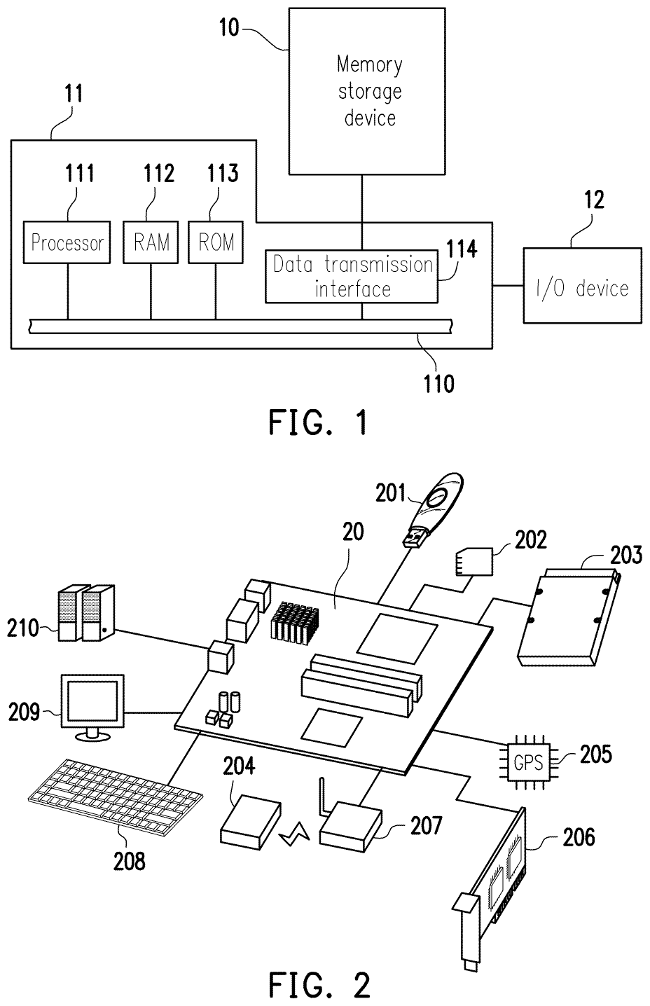

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For example, the host system 11 may store data to or read data from the memory storage device 10 via the data transmission interface 114. In addition, the host system 11 may be coupled to an I/O device 12 through the system bus 110. For example, the host system 11 may transmit output signals to or receive input signals from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or more. The motherboard 20 may be coupled to the memory storage device 10 through the data transmission interface 114 via a wired or wireless connection.

In an exemplary embodiment, the memory storage device 10 may be, for example, a flash drive 201, a memory card 202, a solid state drive (SSD) 203, or a wireless memory storage device 204. The wireless memory storage device 204 may be a memory storage device based on various wireless communication technologies, such as a near field communication (NFC) memory storage device, a wireless fax (WiFi) memory storage device, a Bluetooth memory storage device, a low power Bluetooth memory storage device (e.g. iBeacon), etc. In addition, the motherboard 20 may also be coupled to various I/O devices, such as a global positioning system (GPS) module 205, a network interface card 206, a wireless transmission device 207, a keyboard 208, a screen 209, a speaker 210, etc., through the system bus 110. For example, in an exemplary embodiment, the motherboard 20 may access the wireless memory storage device 204 through the wireless transmission device 207.

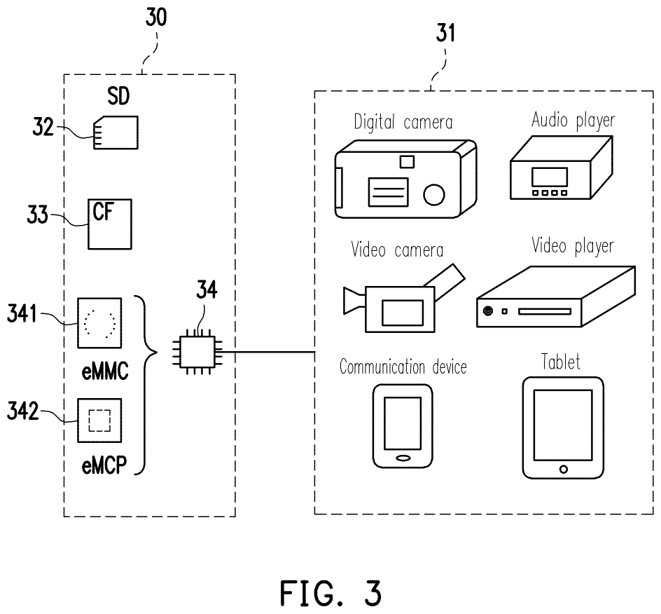

In an exemplary embodiment, the host system 11 is a computer system. In an exemplary embodiment, the host system 11 can be any system that can substantially cooperate with a memory storage device to store data. In an exemplary embodiment, the memory storage device 10 and the host system 11 may respectively include the memory storage device 30 and the host system 31 of FIG. 3.

FIG. 3 is a schematic diagram of a host system and a memory storage device according to an exemplary embodiment of the disclosure. Referring to FIG. 3, the memory storage device 30 can be used in conjunction with the host system 31 to store data. For example, the host system 31 may be a system such as a digital camera, a video camera, a communication device, an audio player, a video player, or a tablet, etc. For example, the memory storage device 30 can be various non-volatile memory storage devices, such as a secure digital (SD) card 32, a compact flash (CF) card 33, or an embedded storage device 34, etc., used in the host system 31. The embedded storage device 34 includes various embedded storage devices that directly couple a memory module to a substrate of the host system, such as an embedded multimedia card (eMMC) 341 and/or an embedded multi-chip package (eMCP) storage device 342, etc.

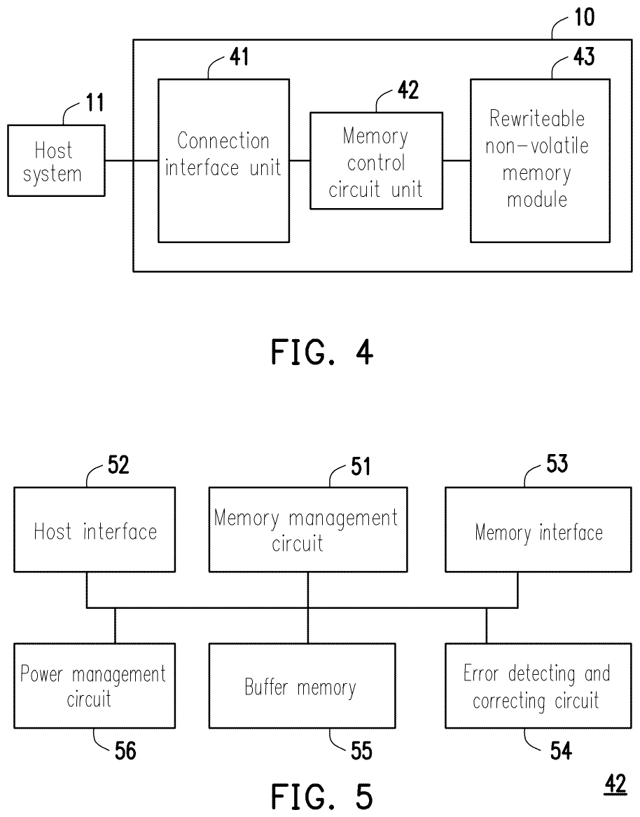

FIG. 4 is a schematic diagram of a memory storage device according to an exemplary embodiment of the disclosure. Referring to FIG. 4, the memory storage device 10 includes a connection interface unit 41, a memory control circuit unit 42, and a rewritable non-volatile memory module 43.

The connection interface unit 41 is configured to couple to a host system 11. The memory storage device 10 can communicate with the host system 11 via the connection interface unit 41. In an exemplary embodiment, the connection interface unit 41 is compatible with the peripheral component interconnect express (PCI Express) standard. In an exemplary embodiment, the connection interface unit 41 may also be compliant to the serial advanced technology attachment (SATA) standard, the parallel advanced technology attachment (PATA) standard, the institute of electrical and electronics engineers (IEEE) 1394 standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 may be packaged in a chip with the memory control circuit unit 42, or the connection interface unit 41 may be disposed outside a chip including the memory control circuit unit 42.

The memory control circuit unit 42 is coupled to the connection interface unit 41 and the rewritable non-volatile memory module 43. The memory control circuit unit 42 is used to execute multiple logical gates or control commands implemented in a hardware form or a firmware form and to perform operations such as writing, reading, and erasing of data in the rewritable non-volatile memory module 43 according to the commands of the host system 11.

The rewritable non-volatile memory module 43 is used to store the data written by the host system 11. The rewritable non-volatile memory module 43 may include a single level cell (SLC) NAND-type flash memory module (i.e., a flash memory that can store 1 bit in one memory cell), multi-level cell (MLC) NAND-type flash memory module (i.e., a flash memory module that can store 2 bits in one memory cell), a triple level cell (TLC) NAND-type flash memory module (i.e., a flash memory module that can store 3 bits in one memory cell), a quad level cell (QLC) NAND-type flash memory module (i.e., a flash memory module that can store 4 bits in one memory cell), other types of flash memory modules, or other memory modules with the same or similar characteristics.

Each memory cell in the rewritable non-volatile memory module 43 stores one or more bits by a change in a voltage (also referred to as a threshold voltage hereinafter). Specifically, there is a charge trapping layer between a control gate and a channel of each of the memory cells. By applying a write voltage to the control gate, the amount of electrons in the charge trapping layer can be changed, thereby changing the threshold voltage of the memory cell. This operation of changing the threshold voltage of the memory cell is also referred to as “writing data to the memory cell” or “programming the memory cell”. As the threshold voltage changes, each of the memory cells in the rewritable non-volatile memory module 43 has multiple storage statuses. By applying a read voltage, it is possible to determine which storage status a memory cell belongs to, thereby obtaining the one or more bits stored in the memory cell.

In an exemplary embodiment, the memory cells of the rewritable non-volatile memory module 43 may constitute multiple physical programming units, and the physical programming units may constitute multiple physical erasing units. Specifically, memory cells on the same word line can form one or more physical programming units. If each memory cell can store two or more bits, the physical programming units on the same word line may be classified at least as lower physical programming units and upper physical programming units. For example, the least significant bit (LSB) of a memory cell belongs to a lower physical programming unit, and the most significant bit (MSB) of a memory cell belongs to an upper physical programming unit. Generally, in an MLC NAND flash memory, the write speed of the lower physical programming unit is greater than the write speed of the upper physical programming unit, and/or the reliability of the lower physical programming unit is higher than the reliability of the upper physical programming unit.

In an exemplary embodiment, the physical programming unit is the minimum unit for programming. That is, the physical programming unit is the minimum unit for writing data. For example, the physical programming unit may be a physical page or a physical sector. If the physical programming unit is a physical page, then the physical programming unit may include a data bit area and a redundancy bit area. The data bit area includes multiple physical sectors is used for storing user data, and the redundancy bit area is used for storing system data (e.g., management data such as error correction codes). In an exemplary embodiment, the data bit area includes 32 physical sectors, and the size of a physical sector is 512 bytes (B). However, in other exemplary embodiments, the data bit area may also include 8, 16, or a greater or lesser number of physical sectors, and the size of each of the physical sectors may also be larger or smaller. On the other hand, the physical erasing unit is the minimum unit for erasing. That is, each of the physical erasing units includes the smallest number of memory cells to be erased together. For example, the physical erasing unit may be a physical block.

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is used to control the overall operation of the memory control circuit unit 42. Specifically, the memory management circuit 51 has multiple control commands, and when the memory storage device 10 operates, the control commands are executed to perform operations such as writing, reading, and erasing data. The following description of the operation of the memory management circuit 51 is equivalent to the description of the operation of the memory control circuit unit 42 and the memory storage device 10.

In an exemplary embodiment, the control commands of the memory management circuit 51 are implemented in a firmware form. For example, the memory management circuit 51 has a microprocessor unit (not shown) and a read only memory (not shown), and the control commands are programmed into the read only memory. When the memory storage device 10 operates, the control commands are executed by the microprocessor unit to perform operations such as writing, reading, and erasing data.

In an exemplary embodiment, the control commands of the memory management circuit 51 may also be stored in a specific area of the rewritable non-volatile memory module 43 (for example, a system area dedicated to storing system data in the memory module) in a program code form. In addition, the memory management circuit 51 has a microprocessor unit (not shown), a read-only memory (not shown), and a random access memory (not shown). In particular, the read only memory has a boot code, and when the memory control circuit unit 42 is enabled, the microprocessor unit first executes the boot code to load the control commands stored in the rewritable non-volatile memory module 43 into the random access memory of the memory management circuit 51. Thereafter, the microprocessor unit runs these control commands to perform operations such as writing, reading, and erasing data.

In an exemplary embodiment, the control commands of the memory management circuit 51 can also be implemented in a hardware form. For example, the memory management circuit 51 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microcontroller. The memory cell management circuit is used to manage the memory cells or a memory cell group of the rewritable non-volatile memory module 43. The memory writing circuit is used to issue a write command sequence to the rewritable non-volatile memory module 43 to write data into the rewritable non-volatile memory module 43. The memory reading circuit is used to issue a read command sequence to the rewritable non-volatile memory module 43 to read data from the rewritable non-volatile memory module 43. The memory erasing circuit is used to issue an erase command sequence to the rewritable non-volatile memory module 43 to erase data from the rewritable non-volatile memory module 43. The data processing circuit is used to process the data to be written into the rewritable non-volatile memory module 43 and the data read from the rewritable non-volatile memory module 43. The write command sequence, the read command sequence and the erase command sequence can respectively include one or more program codes or command codes for instructing the rewritable non-volatile memory module 43 to perform corresponding writing, reading, and erasing operations. In an exemplary embodiment, the memory management circuit 51 may also issue other types of command sequences to the rewritable non-volatile memory module 43 to instruct the rewritable non-volatile memory module 43 to perform corresponding operations.

The host interface 52 is coupled to the memory management circuit 51. The memory management circuit 51 can communicate with the host system 11 through the host interface 52. The host interface 52 can be used to obtain and identify the commands and data of the host system 11. For example, the commands and data of the host system 11 may be transmitted to the memory management circuit 51 through the host interface 52. In addition, the memory management circuit 51 can transmit data to the host system 11 through the host interface 52. In this exemplary embodiment, the host interface 52 is compatible with the PCI Express standard. However, it should be understood that the disclosure is not limited thereto, and the host interface 52 can also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and is used to access the rewritable non-volatile memory module 43. For example, the memory management circuit 51 can access the rewritable non-volatile memory module 43 through the memory interface 53. In other words, the data to be written into the rewritable non-volatile memory module 43 is converted into a format acceptable to the rewritable non-volatile memory module 43 via the memory interface 53. Specifically, if the memory management circuit 51 is to access the rewritable non-volatile memory module 43, the memory interface 53 transmits a corresponding command sequence. For example, the command sequences may include a write command sequence to instruct data writing, a read command sequence to instruct data reading, an erase command sequence to instruct data erasing, and corresponding command sequences for instructing various memory operations (e.g., changing the read voltage level, executing a garbage collection (GC) operation, etc.). These command sequences are, for example, generated by the memory management circuit 51 and transmitted to the rewritable non-volatile memory module 43 via the memory interface 53. These command sequences may include one or more signals or data on the bus. The signals or data may include command codes or program codes. For example, the read command sequence includes information such as the read identification code, the memory address, etc.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to execute an error detecting and correcting operation to ensure the correctness of the data. Specifically, when the memory management circuit 51 obtains a write command from the host system 11, the error detecting and correcting circuit 54 generates a corresponding error correcting code (ECC) and/or error detecting code (EDC) for the data corresponding to the write command, and the memory management circuit 51 writes the data corresponding to the write command and the corresponding error correcting code and/or error detecting code to the rewritable non-volatile memory module 43. Thereafter, when the memory management circuit 51 reads data from the rewritable non-volatile memory module 43, it simultaneously reads the error correcting code and/or the error detecting code corresponding to the data, and the error detecting and correcting circuit 54 executes the error detecting and correcting operation on the read data according to the error correcting code and/or error detecting code. For example, the error detecting and correcting circuit 54 can use various encoding/decoding algorithms such as low density parity check code (LDPC code), BCH code, Reed-Solomon code (RS code), exclusive OR (XOR) code, etc., to encode and decode data.

The buffer memory 55 is coupled to the memory management circuit 51 and used to temporarily store data. The power management circuit 56 is coupled to the memory management circuit 51 and used to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

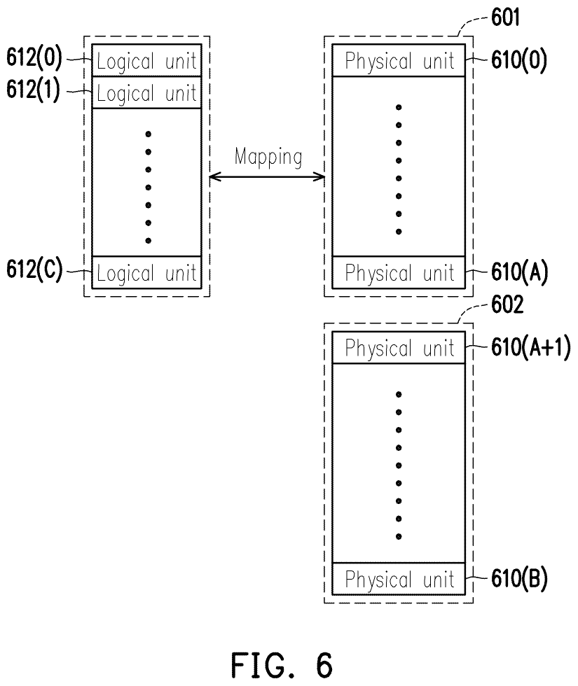

FIG. 6 is a schematic diagram of managing a rewritable non-volatile memory module according to an exemplary embodiment of the disclosure. Referring to FIG. 6, the memory management circuit 51 can logically group the physical units 610(0) to 610(B) in the rewritable non-volatile memory module 43 into a storage area 61 and a spare area 62. For example, a physical unit may include one or more physical erasing units.

In an exemplary embodiment, the physical units 610(0) to 610(A) in the storage area 61 are used to store user data (e.g., user data from the host system 11 of FIG. 1 or FIG. 4). For example, the physical units 610(0) to 610(A) in the storage area 61 can store valid data and invalid data. The physical units 610(A+1) to 610(B) in the spare area 62 do not store data (e.g., valid data). For example, if a certain physical unit does not store valid data, this physical unit can be associated (or added) to the spare area 62. In addition, the physical units in the spare area 62 (or the physical units not storing valid data) can be erased. When new data is written, one or more physical units may be extracted from the spare area 62 to store the new data. In an exemplary embodiment, the spare area 62 is also referred to as a free pool.

In an exemplary embodiment, the logical units 612(0) to 612(C) can be configured in the memory management circuit 51 to map the physical units 610(0) to 610(A) in the storage area 61. For example, a logical unit may include a logical block addresses (LBA) or other logical management units.

It should be noted that a logical unit can be mapped to one or more physical units. If a certain physical unit is currently mapped by a certain logical unit, it means that the data currently stored in this physical unit includes valid data. On the contrary, if a certain physical unit is not currently mapped by any logical unit, it means that the data currently stored in this physical unit is invalid data.

In an exemplary embodiment, the memory management circuit 51 may record the management data (also referred to as the logical to physical mapping information) describing the mapping relationship between logical units and physical units in at least one logical to physical mapping table (L2P table). When the host system 11 reads data from the memory storage device 10 or writes data to the memory storage device 10, the memory management circuit 51 can access the rewritable non-volatile memory module 43 according to the information in the logical to physical mapping table.

In an exemplary embodiment, the memory management circuit 51 can manage the physical units 610(0) to 610(B) based on multiple physical management units. For example, a physical management unit may include N physical units among physical units 610(0) to 610(B), and N may be any integer. In an exemplary embodiment, N may be 1. In an exemplary embodiment, N must be greater than 1. In an exemplary embodiment, N physical units belonging to the same physical management unit can perform the same operation (e.g., a read operation, a write operation, or an erase operation, etc.) synchronously or sequentially. In an exemplary embodiment, a physical management unit is also referred to as a virtual block.

In an exemplary embodiment, the memory management circuit 51 may record count information corresponding to the physical management units. For example, the memory management circuit 51 may uniformly record the count information corresponding to the physical management units in one or more management tables. Alternatively, in an exemplary embodiment, the memory management circuit 51 may record the count information (also referred to as the first count information) corresponding to a certain physical management unit (also referred to as the first physical management unit) in the first physical management unit (e.g., stored in a specific physical unit in the first physical management unit). For example, the first physical management unit may include multiple physical units (also referred to as first physical units) among the physical units 610(0) to 610(B).

In an exemplary embodiment, the count information corresponding to the first physical management unit (i.e., the first count information) may reflect the usage of the first physical management unit. For example, the first count information may be positively related to the usage of the first physical management unit. That is, the greater the value of the first count information, the higher the usage of the first physical management unit.

In an exemplary embodiment, the memory management circuit 51 may determine whether the count information corresponding to the first physical management unit (i.e., the first count information) reaches (e.g., is equal to or greater than) a threshold value. In response to the first count information reaching the threshold value (e.g., the first count information is equal to or greater than the threshold value), the memory management circuit 51 may instruct the rewritable non-volatile memory module 43 to perform a maintenance operation (also referred to as a check operation) on the first physical management unit. The maintenance operation is configured to ensure the reliability of the first physical management unit. However, if the first count information does not reach the threshold value (e.g., the first count information is less than the threshold value), the memory management circuit 51 may not instruct the rewritable non-volatile memory module 43 to perform the maintenance operation on the first physical management unit.

In an exemplary embodiment, during a maintenance operation for the first physical management unit, the memory management circuit 51 may instruct the rewritable non-volatile memory module 43 to read data (also referred to as first data). Then, the memory management circuit 51 may instruct the error detecting and correcting circuit 54 to decode the first data to confirm the correctness of the first data. If the decoding result of the first data reflects that the bit error rate (BER) of the first data is very high (e.g., the bit error rate of the first data is higher than the preset value), the memory management circuit 51 may instruct the rewritable non-volatile memory module 43 to perform error correction and data migration on the first data. For example, in the error correction operation, the memory management circuit 51 may instruct the error detecting and correcting circuit 54 to correct errors in the first data according to the decoding result of the first data. Then, in the data migration operation, the memory management circuit 51 may instruct the rewritable non-volatile memory module 43 to re-store the first data to another physical management unit (also referred to as a second physical management unit) in the rewritable non-volatile memory module 43. For example, the second physical management unit may include multiple physical units (also referred to as second physical units) among the physical units 610(0) to 610(B), and the first physical unit is different from the second physical unit. However, if the decoding result of the first data reflects that the bit error rate (BER) of the first data is not high (e.g., the bit error rate of the first data is not higher than the preset value), the memory management circuit 51 may not instruct the rewritable non-volatile memory module 43 to perform the error correction and the data migration on the first data. In another exemplary embodiment, during the data migration operation, the memory management circuit 51 may also instruct the rewritable non-volatile memory module 43 to re-store all data (including the first data) stored in the first physical management unit to the second physical management unit.

In an exemplary embodiment, by performing the maintenance operation on the physical management units with higher usage, the reliability of at least part of the physical management units can be effectively ensured without significantly increasing the system load. For example, before an abnormal event occurs in some physical management units due to overuse (e.g., the bit error rate of stored data is too high and cannot be successfully decoded), the maintenance operation can immediately perform the error correction and data migration for this physical management unit, thereby avoiding the occurrence of the abnormal event.

However, in practice, the above mechanism may cause too many physical management units to be checked (i.e., perform the maintenance operation) in a short period of time. As a result, some physical management units, despite having met the requisite checking condition, experience significant delays in undergoing checks and/or data updates. In this case, errors may occur in subsequent operations on these physical management units, and the service life of the memory storage device 10 may even be shortened.

In an exemplary embodiment, the memory management circuit 51 may set an initial value of the count information corresponding to at least one of the physical management units to be greater than zero. In addition, the memory management circuit 51 may set initial values of count information corresponding to at least two of the physical management units to be different from each other. Thereby, upon the start of usage of the physical management units, it can be effectively ensured that maintenance operations for at least some of the physical management units among the physical management units will not be triggered at the same time point. Alternatively, from another perspective, by customizing the initial values of the count information corresponding to at least some of the physical management units in the rewritable non-volatile memory module 43, during the subsequent use of the rewritable non-volatile memory module 43, the maintenance operations on different physical management units can be triggered sequentially, thereby improving the aforementioned issues.

In an exemplary embodiment, the memory management circuit 51 may perform a specific operation (also referred to as the first operation) on a specific physical management unit (i.e., the first physical management unit) among the physical management units. For example, the first operation may include at least one of a read operation, a write operation, and an erase operation. The reading operation is configured to read data from the first physical management unit. For example, in the read operation, data may be read synchronously or sequentially from multiple physical units (i.e., the first physical units) belonging to the first physical management unit. The write operation is configured to store data into the first physical management unit. For example, in the write operation, data may be stored synchronously or sequentially into multiple physical units (i.e., the first physical units) of the first physical management unit. The erase operation is configured to erase the first physical management unit. For example, in the erase operation, multiple physical units (i.e., the first physical units) belonging to the first physical management unit may be erased synchronously or sequentially.

In an exemplary embodiment, the memory management circuit 51 may update the count information corresponding to the first physical management unit (i.e., the first count information) according to the first operation after performing the first operation on the first physical management unit based on the customized initial value of the count information. In particular, the (updated) first count information may reflect the number of times the first operation is performed on the first physical management unit (also referred to as the reference number of times), and the reference number of times is greater than another number of times (also referred to as the actual number of times) of performing the first operation on the first physical management unit. For example, assuming that the initial value of the first count information is “25”, after performing the first operation “30 times” on the first physical management unit, the reference number of times reflected by the (updated) first count information is “55” (i.e., 25+30=55), and the current actual number of times corresponding to the first operation performed on the first physical management unit is “30”.

In an exemplary embodiment, the first count information may include first type count information and second type count information. The first type count information may reflect the reference number of times (e.g., “55”). The second type count information may reflect the actual number of times (e.g., “30”).

In an exemplary embodiment, for a first operation (e.g., a read operation and/or a write operation) of a specific type (also referred to as the first type), the memory management circuit 51 may compare the recorded first type count information with the threshold value. For example, the first type count information recorded for the first operation of the first type may reflect the reference number of times the first operation of the first type is performed on the first physical management unit. If the first type count information reaches (e.g., is equal to or greater than) the threshold value, the memory management circuit 51 may instruct the first physical management unit to perform the maintenance operation. However, if the first type count information does not reach (e.g., is less than) the threshold value, the memory management circuit 51 may not instruct the first physical management unit to perform the maintenance operation.

In an exemplary embodiment, for a first operation (e.g., an erase operation) of another type (also referred to as a second type), the memory management circuit 51 may compare the recorded second type count information with the threshold value. For example, the second type count information recorded for the first operation of the second type may reflect the actual number of times the first operation of the second type is performed on the first physical management unit. If the second type count information reaches (e.g., is equal to or greater than) the threshold value, the memory management circuit 51 may instruct the first physical management unit to perform the maintenance operation. However, if the second type count information does not reach (e.g., is less than) the threshold value, the memory management circuit 51 may not instruct the first physical management unit to perform the maintenance operation.

In an exemplary embodiment, for a first operation of the first type (e.g., a read operation and/or a write operation), the memory management circuit 51 can only record the first type count information (i.e., not record the second type count information) to save system resources. In an exemplary embodiment, for a first operation of the second type (e.g., an erase operation), the memory management circuit 51 can synchronously record the first type count information and the second type count information to improve the detection performance of the first physical management unit for the first operation of the second type (e.g., an erase operation).

In an exemplary embodiment, after performing the maintenance operation on the first physical management unit, the memory management circuit 51 may reset the count information (i.e., the first count information) corresponding to the first physical management unit. For example, in an exemplary embodiment, during the operation of resetting the first count information, the memory management circuit 51 may restore the first count information to a preset value. For example, this preset value can be zero or another number. Alternatively, in an exemplary embodiment, during the operation of resetting the first count information, the memory management circuit 51 may restore the first count information to the initial value of the first count information. In particular, the initial value of the first count information may be greater than zero. Thereafter, after performing the first operation on the first physical management unit again, the first count information can be updated again based on the initial value.

In an exemplary embodiment, the memory management circuit 51 can obtain a random number. For example, the memory management circuit 51 can generate the random number through a random number generator. For example, the memory management circuit 51 may input a parameter as a seed to the random number generator. A random number generator can generate output based on this parameter (i.e., the seed). The memory management circuit 51 can obtain the random number based on this output.

In an exemplary embodiment, the memory management circuit 51 may set an initial value of the count information (e.g., the first count information) corresponding to at least one of the physical management units according to the random number. For example, the memory management circuit 51 can directly set the random number as the initial value of the first count information. Alternatively, the memory management circuit 51 may perform a logical operation on the random value to obtain the initial value of the first count information. In an exemplary embodiment, the random number can also be generated through a lookup table or other methods, which is not limited by the disclosure.

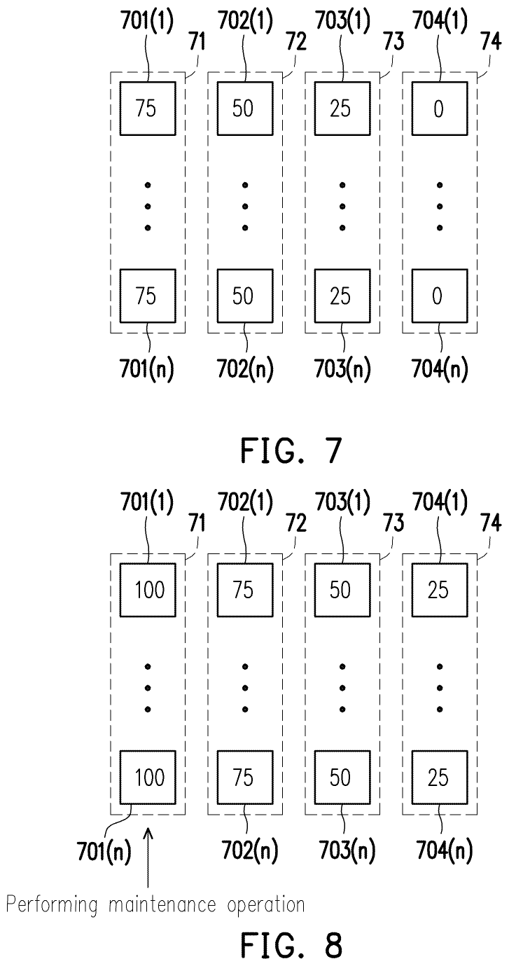

FIG. 7 is a schematic diagram of setting customized initial values of the count information for multiple physical management units according to an exemplary embodiment of the disclosure. Referring to FIG. 7, it is assumed that the rewritable non-volatile memory module 43 includes physical management units 71 to 74. The physical management unit 71 includes physical units 701(1) to 701(n). The physical management unit 72 includes physical units 702(1) to 702(n). The physical management unit 73 includes physical units 703(1) to 703(n). The physical management unit 74 includes physical units 704(1) to 704(n).

In an exemplary embodiment, the memory management circuit 51 may respectively set the initial values of the count information corresponding to the physical management units 71 to 74 to “75”, “50”, “25” and “0”. For example, at least one of the four initial values can be set through a lookup table or obtaining a random number, which is not limited by the disclosure.

FIG. 8 to FIG. 11 are schematic diagrams of updating count information based on the customized initial value of the count information and performing corresponding operation according to exemplary embodiments of the disclosure. Referring to FIG. 8, after the physical management units 71 to 74 have been used for a period of time, it is assumed that the count information corresponding to the physical management units 71 to 74 are respectively updated to “100”, “75”, “50” and “25” based on their respective initial values.

That is, in the exemplary embodiment of FIG. 8, it is assumed that within a time range, the first operation (e.g., a read operation, a write operation or an erase operation) are performed “25 times” on the physical management units 71 to 74 respectively. In this case, the count information “100”, “75”, “50” and “25” respectively represent the reference number of times corresponding to the physical management units 71 to 74. In particular, the reference number of times corresponding to the physical management units 71 to 73 (i.e., “100”, “75” and “50”) are all greater than the actual number of times of performing the first operation on the physical management units 71 to 73 (i.e., “25”). Furthermore, the reference number of times corresponding to the physical management unit 74 (i.e., “25”) is equal to the actual number of times of performing the first operation on the physical management unit 74 (i.e., “25”).

In response to the count information (i.e., “100”) corresponding to the physical management unit 71 reaching a threshold value (e.g., “100”), the memory management circuit 51 may instruct the rewritable non-volatile memory module 43 to perform the maintenance operation on the physical management unit 71 (i.e., the physical units 701(1) to 701(n)). The operational details of the maintenance operation have been described in detail above and are not repeated herein. In addition, the count information corresponding to the physical management units 72 to 74 (i.e., “75”, “50” and “25”) does not reach the threshold value (e.g., “100”), the memory management circuit 51 may not instruct the rewritable non-volatile memory module 43 to perform the maintenance operation on the physical management units 72 to 74.

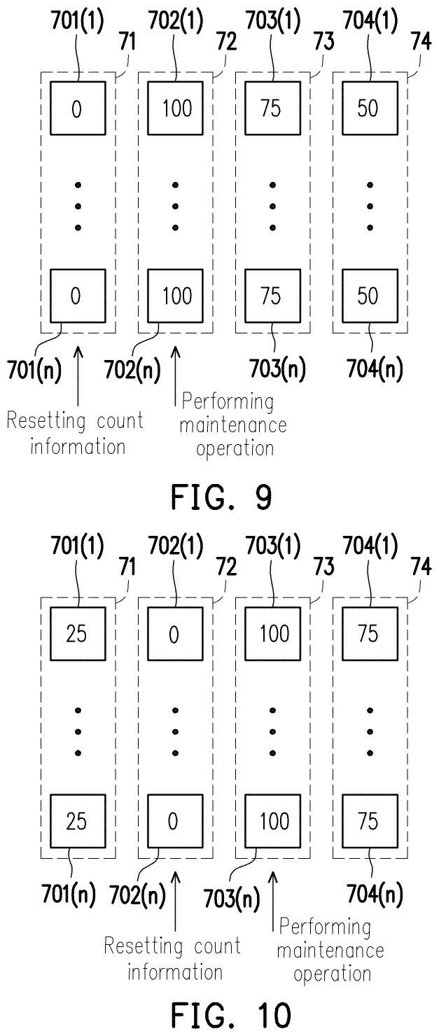

Referring to FIG. 9, continuing from the exemplary embodiment of FIG. 8, after performing the maintenance operation on the physical management unit 71, the memory management circuit 51 may reset the count information corresponding to the physical management unit 71. For example, the memory management circuit 51 may restore the count information corresponding to the physical management unit 71 to “0” (i.e., the preset value).

On the other hand, in the exemplary embodiment of FIG. 9, after performing the maintenance operation on the physical management unit 71 and using the physical management units 71 to 74 for a period of time, it is assumed that the count information corresponding to the physical management units 71 to 74 are updated to “0” (reset), “100”, “75” and “50”. In response to the count information (i.e., “100”) corresponding to the physical management unit 72 reaching a threshold value (e.g., “100”), the memory management circuit 51 may instruct the rewritable non-volatile memory module 43 to perform the maintenance operation on the physical management unit 72 (i.e., the physical units 702(1) to 702(n)). The operational details of the maintenance operation have been described in detail above and are not repeated herein. In addition, the count information corresponding to the physical management units 71, 73 and 74 (i.e., “0”, “75” and “50”) does not reach the threshold value (e.g., “100”), the memory management circuit 51 may not instruct the rewritable non-volatile memory module 43 to perform the maintenance operation on the physical management units 71, 73 and 74.

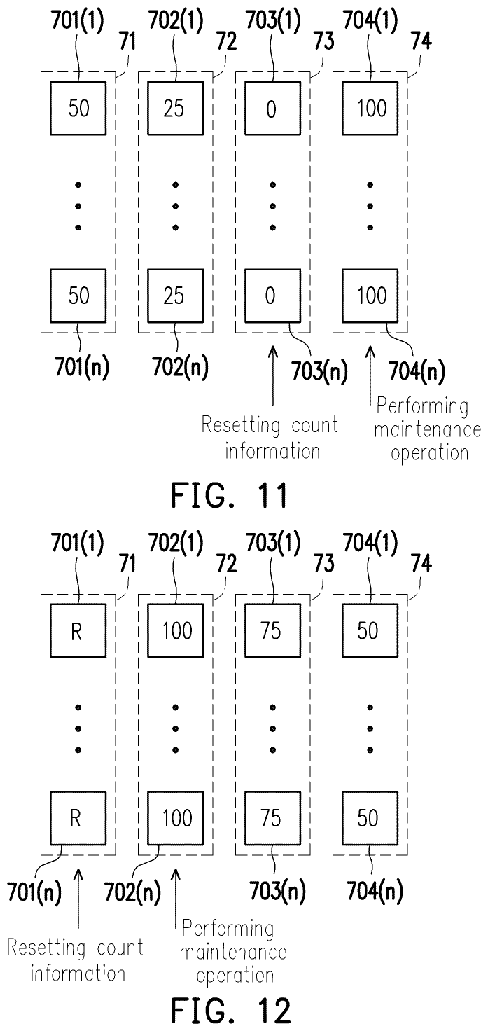

Referring to FIG. 10, continuing from the exemplary embodiment of FIG. 9, after performing the maintenance operation on the physical management unit 72, the memory management circuit 51 may reset the count information corresponding to the physical management unit 72. For example, the memory management circuit 51 may restore the count information corresponding to the physical management unit 72 to “0” (i.e., the preset value).

On the other hand, in the exemplary embodiment of FIG. 10, after performing the maintenance operation on the physical management unit 72 and using the physical management units 71 to 74 for a period of time, it is assumed that the count information corresponding to the physical management units 71 to 74 are updated to “25”, “0” (reset), “100” and “75”. In response to the count information (i.e., “100”) corresponding to the physical management unit 73 reaching a threshold value (e.g., “100”), the memory management circuit 51 may instruct the rewritable non-volatile memory module 43 to perform the maintenance operation on the physical management unit 73 (i.e., the physical units 703(1) to 703(n)). The operational details of the maintenance operation have been described in detail above and are not repeated herein. In addition, the count information corresponding to the physical management units 71, 72 and 74 (i.e., “25”, “0” and “75”) does not reach the threshold value (e.g., “100”), the memory management circuit 51 may not instruct the rewritable non-volatile memory module 43 to perform the maintenance operation on the physical management units 71, 72 and 74.

Referring to FIG. 11, continuing from the exemplary embodiment of FIG. 10, after performing the maintenance operation on the physical management unit 73, the memory management circuit 51 may reset the count information corresponding to the physical management unit 73. For example, the memory management circuit 51 may restore the count information corresponding to the physical management unit 73 to “0” (i.e., the preset value).

On the other hand, in the exemplary embodiment of FIG. 11, after performing the maintenance operation on the physical management unit 73 and using the physical management units 71 to 74 for a period of time, it is assumed that the count information corresponding to the physical management units 71 to 74 are updated to “50”, “25”, “0” (reset) and “100”. In response to the count information (i.e., “100”) corresponding to the physical management unit 74 reaching a threshold value (e.g., “100”), the memory management circuit 51 may instruct the rewritable non-volatile memory module 43 to perform the maintenance operation on the physical management unit 74 (i.e., the physical units 704(1) to 704(n)). The operational details of the maintenance operation have been described in detail above and are not repeated herein. In addition, the count information corresponding to the physical management units 71 to 73 (i.e., “50”, “25” and “0”) does not reach the threshold value (e.g., “100”), the memory management circuit 51 may not instruct the rewritable non-volatile memory module 43 to perform the maintenance operation on the physical management units 71 to 73.

In other words, the exemplary embodiments of FIG. 8 to FIG. 11 completely demonstrate that, during the use of the rewritable non-volatile memory module 43, the maintenance operations for different physical management units (e.g., the physical management units 71 to 74) can be triggered sequentially by using customized initial values of count information. This can effectively improve a series of problems that may arise from the excessive number of physical management units (such as memory blocks) that need to be checked at the same time (or within a short period of time), thereby extending the service life of the memory storage device 10.

FIG. 12 is a schematic diagram of resetting count information according to an exemplary embodiment of the disclosure. Referring to FIG. 12, continuing from the exemplary embodiment of FIG. 8, after performing the maintenance operation on the physical management unit 71, the memory management circuit 51 may reset the count information corresponding to the physical management unit 71.

It should be noted that, compared with the exemplary embodiment of FIG. 9, in the exemplary embodiment of FIG. 12, the memory management circuit 51 can restore the count information corresponding to the physical management unit 71 to the initial value (indicated by “R”) corresponding to the count information of the physical management unit 71. For example, the initial value “R” can be determined according to a random number. The relevant operation details have been described in detail above, and are not repeated herein. By analogy, in the operation of resetting the count information corresponding to the physical management units 72 to 74, the initial value of each count information may also be determined according to the corresponding random number.

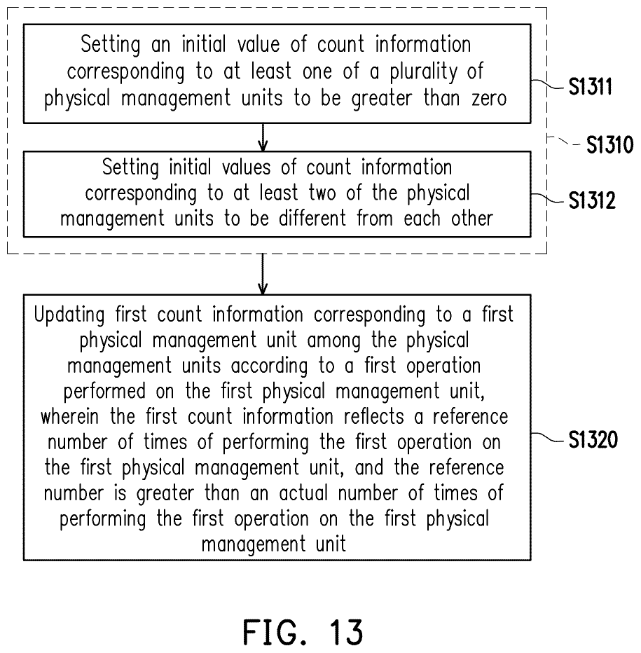

FIG. 13 is a flowchart of a memory management method according to an exemplary embodiment of the disclosure. Referring to FIG. 13, in step S1310, a customized initial value of the count information is set. For example, step S1310 includes steps S1311 and S1312. In step S1311, the initial value of the count information corresponding to at least one of the physical management units is set to be greater than zero. In step S1312, the initial values of count information corresponding to at least two of the physical management units are set to be different from each other. It should be noted that the disclosure does not limit the execution order of steps S1311 and S1312. In step S1320, the first count information corresponding to the first physical management unit among the physical management units is updated according to a first operation performed on a first physical management unit. The first count information reflects the reference number of times of performing the first operation on the first physical management unit, and the reference number of times is greater than the actual number of times of performing the first operation on the first physical management unit.

However, each step in FIG. 13 has been described in detail as above, and are not repeated herein. It should be noted that each of the steps in FIG. 13 can be implemented as multiple program codes or circuits, and the disclosure is not limited thereto. In addition, the method in FIG. 13 can be used in conjunction with the above-mentioned exemplary embodiments, or can be used alone, and the disclosure is not limited thereto.

To sum up, the memory management method, the memory storage device, and the memory control circuit unit provided in the exemplary embodiments of the disclosure can force distributed (e.g., sequential) triggering of subsequent maintenance operations on multiple physical management units by setting a customized initial value of the count information. This can improve a series of problems that may arise from the excessive number of physical management units (such as memory blocks) that need to be checked at the same time (or within a short period of time), thereby extending the service life of the memory storage device.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

1. A memory management method for a rewritable non-volatile memory module, wherein the rewritable non-volatile memory module comprises a plurality of physical management units, and the memory management method comprises:
setting an initial value of count information corresponding to at least one of the physical management units to be greater than zero;
setting initial values of count information corresponding to at least two of the physical management units to be different from each other; and
updating first count information corresponding to a first physical management unit among the physical management units according to a first operation performed on the first physical management unit and an initial value of the first count information,
wherein the updated first count information reflects a reference number of times of performing the first operation on the first physical management unit, and the reference number of times is greater than an actual number of times of performing the first operation on the first physical management unit.

2. The memory management method according to claim 1, wherein the first operation comprises at least one of a read operation, a write operation, and an erase operation.

3. The memory management method according to claim 1, wherein the first count information comprises a first type count information and a second type count information, the first type count information reflects the reference number of times, and the second type count information reflects the actual number of times.

4. The memory management method according to claim 1, further comprising:
in response to the first count information reaching a threshold value, instructing a maintenance operation to be performed on the first physical management unit, wherein the maintenance operation is configured to ensure reliability of the first physical management unit.

5. The memory management method according to claim 4, further comprising:
resetting the first count information after performing the maintenance operation on the first physical management unit.

6. The memory management method according to claim 5, wherein resetting the first count information comprises:
restoring the first count information to a preset value.

7. The memory management method according to claim 5, wherein resetting the first count information comprises:
restoring the first count information to the initial value of the first count information, wherein the initial value of the first count information is greater than zero.

8. The memory management method according to claim 1, further comprising:
obtaining a random number; and
setting the initial value of the count information corresponding to the at least one of the physical management units according to the random number.

9. A memory storage device, comprising:
a connection interface unit, configured to couple to a host system;
a rewritable non-volatile memory module, and
a memory control circuit unit, coupled to the connection interface unit and the rewritable non-volatile memory module,
wherein the rewritable non-volatile memory module comprises a plurality of physical management units, and the memory control circuit unit is configured to:
set an initial value of count information corresponding to at least one of the physical management units to be greater than zero;
set initial values of count information corresponding to at least two of the physical management units to be different from each other; and
update first count information corresponding to a first physical management unit among the physical management units according to a first operation performed on the first physical management unit and an initial value of the first count information,
wherein the updated first count information reflects a reference number of times of performing the first operation on the first physical management unit, and the reference number of times is greater than an actual number of times of performing the first operation on the first physical management unit.

10. The memory storage device according to claim 9, wherein the first operation comprises at least one of a read operation, a write operation, and an erase operation.

11. The memory storage device according to claim 9, wherein the first count information comprises a first type count information and a second type count information, the first type count information reflects the reference number of times, and the second type count information reflects the actual number of times.

12. The memory storage device according to claim 9, wherein the memory control circuit unit is further configured to:
in response to the first count information reaching a threshold value, instruct a maintenance operation to be performed on the first physical management unit, wherein the maintenance operation is configured to ensure reliability of the first physical management unit.

13. The memory storage device according to claim 12, wherein the memory control circuit unit is further configured to:
reset the first count information after performing the maintenance operation on the first physical management unit.

14. The memory storage device according to claim 13, wherein resetting the first count information by the memory control circuit unit comprises:
restoring the first count information to a preset value.

15. The memory storage device according to claim 13, wherein resetting the first count information by the memory control circuit unit comprises:
restoring the first count information to the initial value of the first count information, wherein the initial value of the first count information is greater than zero.

16. The memory storage device according to claim 9, wherein the memory control circuit unit is further configured to:
obtain a random number; and
set the initial value of the count information corresponding to the at least one of the physical management units according to the random number.

17. A memory control circuit unit, for controlling a memory storage device, wherein the memory storage device comprises a rewritable non-volatile memory module, and the memory control circuit unit comprises:
a host interface, configured to couple to a host system;
a memory interface, configured to couple to the rewritable non-volatile memory module; and
a memory management circuit, coupled to the host interface and the memory interface,
wherein the rewritable non-volatile memory module comprises a plurality of physical management units, and the memory management circuit is configured to:
set an initial value of count information corresponding to at least one of the physical management units to be greater than zero;
set initial values of count information corresponding to at least two of the physical management units to be different from each other; and
update first count information corresponding to a first physical management unit among the physical management units according to a first operation performed on the first physical management unit and an initial value of the first count information,
wherein the updated first count information reflects a reference number of times of performing the first operation on the first physical management unit, and the reference number of times is greater than an actual number of times of performing the first operation on the first physical management unit.

18. The memory control circuit unit according to claim 17, wherein the first operation comprises at least one of a read operation, a write operation, and an erase operation.

19. The memory control circuit unit according to claim 17, wherein the first count information comprises a first type count information and a second type count information, the first type count information reflects the reference number of times, and the second type count information reflects the actual number of times.

20. The memory control circuit unit according to claim 17, wherein the memory management circuit is further configured to:
in response to the first count information reaching a threshold value, instruct a maintenance operation to be performed on the first physical management unit, wherein the maintenance operation is configured to ensure reliability of the first physical management unit.

21. The memory control circuit unit according to claim 20, wherein the memory management circuit is further configured to:
reset the first count information after performing the maintenance operation on the first physical management unit.

22. The memory control circuit unit according to claim 21, wherein resetting the first count information by the memory management circuit comprises:
restoring the first count information to a preset value.

23. The memory control circuit unit according to claim 21, wherein resetting the first count information by the memory management circuit comprises:
restoring the first count information to the initial value of the first count information, wherein the initial value of the first count information is greater than zero.

24. The memory control circuit unit according to claim 17, wherein the memory management circuit is further configured to:
obtain a random number; and
set the initial value of the count information corresponding to the at least one of the physical management units according to the random number.
